(19) United States
(12) Patent Application Publication
(10) Pub. No.: US 2007/0094356 A1
(43) Pub. Date: Apr. 26, 2007

(54) System and method for context aware profiling for wireless networks

(76) Inventors: Aseem Sethi, Bangalore (IN); Naresh Sunkara, Bangalore (IN); Amit Phadnis, Bangalore (IN)

Correspondence Address: FAY KAPLUN & MARCIN, LLP, 15O BROADWAY, SUITE 702, NEW YORK, NY, 10038, US

(21) Appl. No.: 11/258,259

(22) Filed: Oct. 25, 2005

(51) Int. Cl. G06F 15/16

(52) U.S. Cl. 709/219; 709/228

(57) ABSTRACT

Described is a method and system for context aware profiling for wireless networks. The system may include a mobile unit and an access point. The mobile unit may includes a plurality of predefined contexts; each context including corresponding network settings. The mobile unit selects one of the predefined contexts and formatting and transmitting a request signal to enable the one of the predefined contexts. The access point includes the plurality of predefined contexts and receives the request signal from the mobile unit. The access point determines if the mobile unit has permission to enable the one of the predefined contexts and sends one of a permission signal and a denial signal to the mobile unit. When a permission signal is sent, the access point and the mobile unit apply the network settings corresponding to the one of the predefined contexts.

### BACKGROUND INFORMATION

Wireless technology has increased productivity and efficiency of workers. Workers can move from their personal work-spaces, to meetings, to training classes, etc. while remaining connected to a wireless network with a wireless-enabled mobile unit (“MU”). Therefore, having a comprehensive wireless network allows employees to perform work and access the network in places where they were traditionally not previously able to do so. In order to organize different wireless networks an MU may encounter, many software programs, including Microsoft's Windows XP, allow the user to configure profiles. These profiles include information that would allow a user to connect to a specific wireless network such as a network's service set identifier (“SSID”), the channel on which the network is operating, the wired equivalent protection (“WEP”) password/key, etc.

Although these profiles store information and settings that allow MUs to connect to different networks, the profiles only change a few specific settings of the MUs to facilitate connecting to different wireless networks. Furthermore, these profiles do not change any settings of the AP, of any settings of the that pertain to the MU user's work environment. If a user desires to change his/her network settings because he/she is in a certain work environment, all settings must be altered manually. There may be situations where users have preferred network settings for their MUs, APs, and other MUs in certain work environments, but changing these settings each time the user changes his/her work environment (e.g. attends a meeting, training session, or returns to his/her personal office/cubicle) proves to be time consuming, thus reducing the productivity of the user.

### SUMMARY OF THE INVENTION

The present invention relates to a method and system for context aware profiling for wireless networks. The system may include a mobile unit and an access point. The mobile unit may includes a plurality of predefined contexts; each context including corresponding network settings. The mobile unit selects one of the predefined contexts and formatting and transmitting a request signal to enable the one of the predefined contexts. The access point includes the plurality of predefined contexts and receives the request signal from the mobile unit. The access point determines if the mobile unit has permission to enable the one of the predefined contexts and sends one of a permission signal and a denial signal to the mobile unit. When a permission signal is sent, the access point and the mobile unit apply the network settings corresponding to the one of the predefined contexts.

### BRIEF DESCRIPTION OF THE DRAWINGS

FIG. 1 is an exemplary embodiment of a system according to the present invention; and

FIG. 2 is an exemplary embodiment of a method according to the present invention.

### DETAILED DESCRIPTION

The present invention may be further understood with reference to the following description and the appended drawings. The present invention provides a system and a method for setting, enabling, disabling, activating, and deactivating a Context. A Context comprises specific network settings for a wireless-enabled mobile unit (“MU”) and/or an access point (“AP”) that can be automatically configured to provide different network service levels depending on the work environment of the user. These Contexts may comprise Main-Contexts, which may include general settings for general situations, and Sub Contexts, allowing users to further customize their settings to adapt to more specific work environments/situations.

Those of skill in the art will understand that the following will provide examples of what is referred to as a “Context” in this description, but the entity described may have any designation. Furthermore, the network settings described for particular contexts are only an exemplary embodiment of the present invention. Any number of other settings may be defined and used for contexts. Moreover, although the present invention will be described with respect to a laptop computer and an IEEE802.11 AP, those of skill in the art will understand that the present invention may be applied to any wireless-enabled device and network.

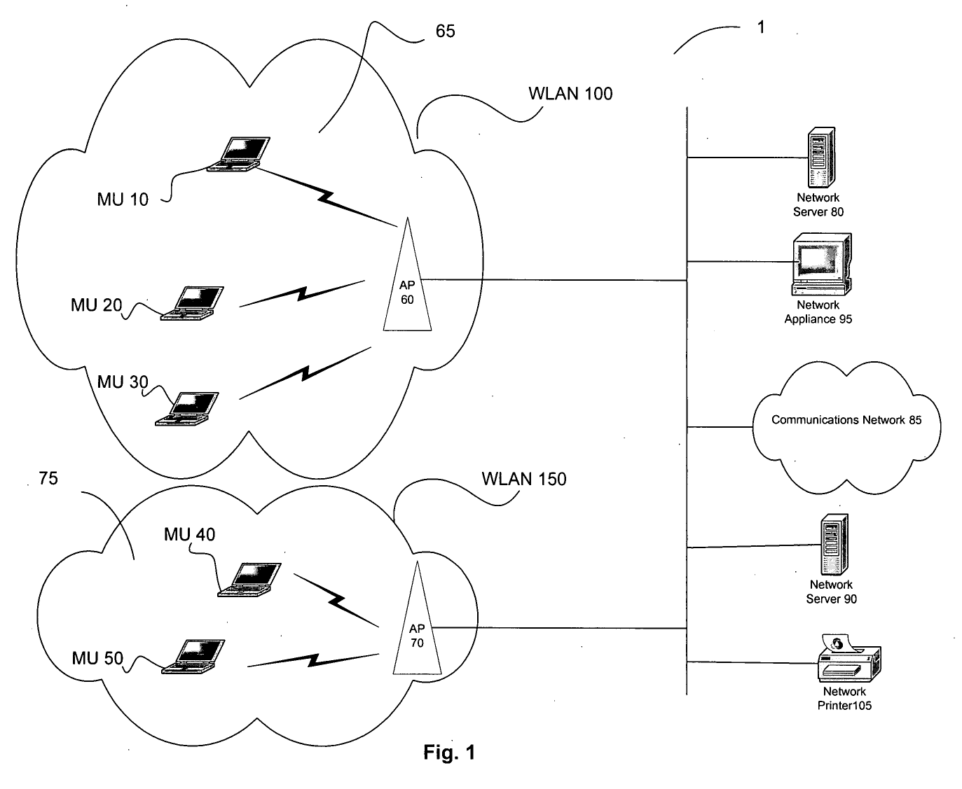

FIG. 1 shows an exemplary embodiment of a network 1. This exemplary embodiment has a first wireless local area network (“WLAN”) 100 and a second WLAN 150. The WLAN 100 includes an AP 60 having a coverage area 65. Wireless-enabled mobile units (“MUs”) 10, 20 and 30 are currently within the coverage area 65 of the AP 60 and have associated with the AP 60. The MUs 10, 20 and 30 may be any type of wirelessly enabled device, for example, personal data assistants (“PDAs”), laptop computers, mobile computing devices, etc. Once these MUs 10, 20 and 30 are associated with the AP 60, the MUs 10, 20 and 30 may communicate with other devices connected to the network 1. Similarly, the WLAN 150 includes an AP 70 having coverage area 75. Wireless-enabled MUs 40 and 50 are currently within the coverage area 75 of the AP 70 and have become associated with the AP 70. Again, once these MUs 40 and 50 are associated with the AP 70, the MUs 40 and 50 may communicate with other devices connected to the network 1.

Those of skill in the art will understand that there are numerous manners for MUs to associate with APs and that these associations are usually governed by the communication standard/protocol being used in the particular WLAN, e.g., IEEE 802.11x, etc. The exemplary embodiments of the present invention are not limited to any particular type of WLAN protocol and/or association method.

The network 1 may include a plurality of other network devices such as network servers 80 and 90, network appliance 95, network printer 105, etc., connected to a wired portion of the network 1. In addition, the network 1 may be connected to another communications network 85, such as an organization's intranet, the Internet, etc. The communications network 85 and the connection thereto may include infrastructure devices such as routers, switches, servers, gateways, firewalls, etc.

Those skilled in the art will understand that the network 1 is only exemplary and that the exemplary embodiments of the present invention may be implemented on any type of network. For example, the WLANs 100 and 200 may include any number of APs and MUs, and be connected to any number of communication networks.

As shown in FIG. 1, the AP 60 provides a wireless connection for the MUs 10, 20 and 30 and the AP 70 provides a wireless connection for MUs 40 and 50. The APs 60 and 70 may be operating on different channels, have different service set identifiers (“SSID”), different wired-equivalent protection (“WEP”) passwords/keys, etc. If the MU 10 were to leave the coverage area 65 so that it would no longer be connected to WLAN 100 through AP 60, but be connected to WLAN 200 through AP 70, MU 10 may have a profile set up for both wireless networks, containing information such as the SSID, WEP password/key, and channel so it would be able to easily switch between WLANs.

Although profiles allow easy transitions between wireless networks, they do not alter any settings regarding level of service at the AP, or any other network settings besides information that allows the MUs to associate with a given WLAN. In this manner, profiles are extremely limited in their functionality. If a user desires to change other network settings, and the level of service (e.g. peer-to-peer networking, enabling/disabling of voice over internet protocol (“VoIP”), ad hoc-networking, etc.), the user would have to go about making the changes manually, and may have to log into the AP to make changes at that level as well.

According to the exemplary embodiments of the present invention, the user of a MU within the wireless network would be able to select from certain Main-Contexts and Sub-Contexts as the user changes work environments/situations. These contexts may store network settings of the MU and the AP (e.g. peer-to-peer, ad hoc, VoIP traffic, etc) depending on the selected context. The contexts are not related to any particular SSID of an access point or to the user ID of the user. Rather, each context is a dynamic entity wherein the user may change between different contexts, thereby changing the service level dynamically within the network. It should also be noted that the above described network 1 included two different WLANs which will be described below as implementing different contexts. However, different contexts may also be implemented within a single WLAN.

In one exemplary embodiment, a Personal Work Space Main-Context may be defined. The defining of contexts (Main-Contexts and Sub-Contexts) may be performed by the network provider, a network administrator, users, etc. In this example, the Personal Work Space Context may include the following network settings:
a. disable peer-to-peer applications;
b. disable ad hoc-networking;
c. enable VoIP applications;
d. dis-allow routing/packets to go via this MU to enable mesh networking; and
e. allow electronic mail (“email”) SMTP traffic and HTTP traffic only, etc.
   Those of skill in the art will understand that this is not a comprehensive list of network settings that can be activated by the Context, but rather a representative subset of possible settings that may be defined for this particular context.

In a second exemplary embodiment, a Conference Main-Context may also be defined. This context may include the following network settings:
a. enable peer-to-peer applications;
b. enable ad hoc networking;
c. disable VoIP applications and personal soft/phone
d. allow routing/packets to go via this MU to enable mesh networking;
e. disable email traffic;

These two contexts may be configured at one or more of the MUs 10-50 and at one or more of the APs 60 and 70. As shown above, the contexts may be assigned a number in an index stored on the MUs 10-50 and/or the APs 60 and 70. For example, the Personal Workspace Main-Context may be assigned index number 1 which is the same on the MUs 10-50 and/or the APs 60 and 70. Thus, for example, if it is considered that the office of the user of MU 10 is in the coverage area 65 of AP 60, the user may select the above described Personal Work Space Main-Context when the user is in their office. Assuming that this context is configured at the MU 10 and at the AP 60, the appropriate network settings corresponding to the selected context will be set for the MU 10 and the AP 60. Therefore, the user of the MU 10 will be provided with the desired service level on the MU 10 when the user is in their office.

It may then be considered that the user moves to a different location, e.g., a conference room either in coverage area 65 or 75, to attend a meeting with other colleagues. At this point, the user may enable the Conference Main-Context to obtain the proper network settings for this situation. Again, this assumes that this context is configured at both the MU 10 and the corresponding AP 60 and/or 70. Thus, the user is provided MU 10 with the desired service level on the MU 10 when the user is in the conference room. This example shows that using contexts in accordance with the exemplary embodiments of the present invention, allows a user to dynamically change the service level the user is being provided on an MU based on either location and/or the situation.

As described above, the Main-Contexts may also include Sub-Contexts. The Sub-Contexts may be defined in the same manner described above for Main-Contexts. The Sub-Contexts would also be configured at the MUs and the APs which are configured for the corresponding Main-Context. Thus, the Sub-Contexts are additional selectable network settings that may be used to accomplish specific tasks within the defined Main-Context.

The above example of the Conference Main-Context will be continued to provide an example of a Sub-Context. For example, under the Conference Main-Context the user may have a choice of a plurality of defined Sub-Contexts. One exemplary Sub-Context may be a Projection Sub-Context. This Sub-Context may enable network settings on the APs and the MUs so that all the attendees of the conference to send data to, for example, a wireless-enabled device such as a projector for the data to be projected for the attendees to see the data.

To continue with the example, it may be considered that each of the users of MUs 10, 20 and 30 were attendees and in the same conference room within the coverage area 65 of the AP 60 and that the Conference Main-Context and Projection Sub-Context were configured at each of the MUs 10, 20 and 30 and the AP 60. Thus, when the users started the meeting, each of the users of MUs 10, 20 and 30 may enable the Conference Main-Context and the Projection Sub-Context, thereby configuring the network settings of the MUs 10, 20 and 30 and the AP 60 to operate in accordance with the above description.

It may also be possible to configure the network such that only a single MU enables the Projection Sub-Context so that each attendees' data may be sent to the projector. In this example, an agent may reside on each MU that monitors the enabled contexts and activates the correct settings for the activation. For example, when a particular MU is enabled for the Conference Main-Context, the agent may monitor its associated AP to determine if the Projection Sub-Context has been enabled at the AP. If it is determined that the Projection Sub-Context has been enabled at the AP, e.g., by another attendee of the meeting, the agent will instruct the MU to set the appropriate network settings for the MU to operate in accordance with the projection Sub-Context.

Those of skill in the art will understand that the particular implementation of network settings needed to accomplish a specific task is not important to the exemplary embodiments of the present invention, but rather, that various contexts may be defined so that each user may dynamically enable these network settings to accomplish the tasks is the.

Continuing further with the example, it may also be considered that the users of the MUs 40 and 50 are in a conference room within the coverage area 75 of the AP 70, but these users are also remote attendees of the same meeting. The Conference Main-Context and Projection Sub-Context may also be configured at each of the MUs 40 and 50 and the AP 70. Thus, when the meeting started, each of the users of MUs 40 and 50 may enable the Conference Main-Context and the Projection Sub-Context, thereby configuring the network settings of the MUs 40 and 50 and the AP 70 to also operate in accordance with the above description so that the remote attendees could also participate in the meeting.

Another example of a sub-context under the Conference Main-Context may be a Storage Sub-Context that enables network settings to provide that all meeting data/minutes may be stored to a network device such as, for example, network server 80. A further example a sub-context under the Conference Main-Context may be a Sharing Sub-Context that may allow all attendees of the meeting who are operating under this Sub-Context to share files on their MUs without moving the files to the network, and activate a messaging/chat-room program allowing everyone to communicate. One of skill in the art will understand that there could be an infinite number of combinations of Main-Contexts and Sub-Contexts, and an infinite number of settings that may be applied by each context.

It should be noted that in the above example, each of the MUs that were associated with a particular AP were described with reference to all of the MUs enabling the same context and the MUs and AP having the same enabled network settings corresponding to the enabled context. However, it is also possible that different MUs that are associated with the same AP may have enabled different contexts. Thus, referring to FIG. 1, MU 10 may enable a first context (e.g., an office context), MU 20 may enable a second context (e.g., a meeting context) and MU 30 may enable a third context (e.g., a presentation context), simultaneously. If the AP 60 is configured for each of the three contexts, it may simultaneously handle the communications of each of these MUs 10, 20 and 30 because the network settings may be associated with the particular connection for the particular MU. Thus, an AP is not limited to having a single context enabled at a time, it may enable multiple contexts according to the present invention.

In addition to default Main-Contexts and Sub-Contexts, the organization and/or the users may be able to custom-tailor Contexts. Users and/or organizations may be able to create their own custom Contexts, or alter the settings of existing Contexts. Moreover, if some specific functionality is required, a template may be provided to allow users to create a Context instantly and allow other users to access and utilize the newly created Context.

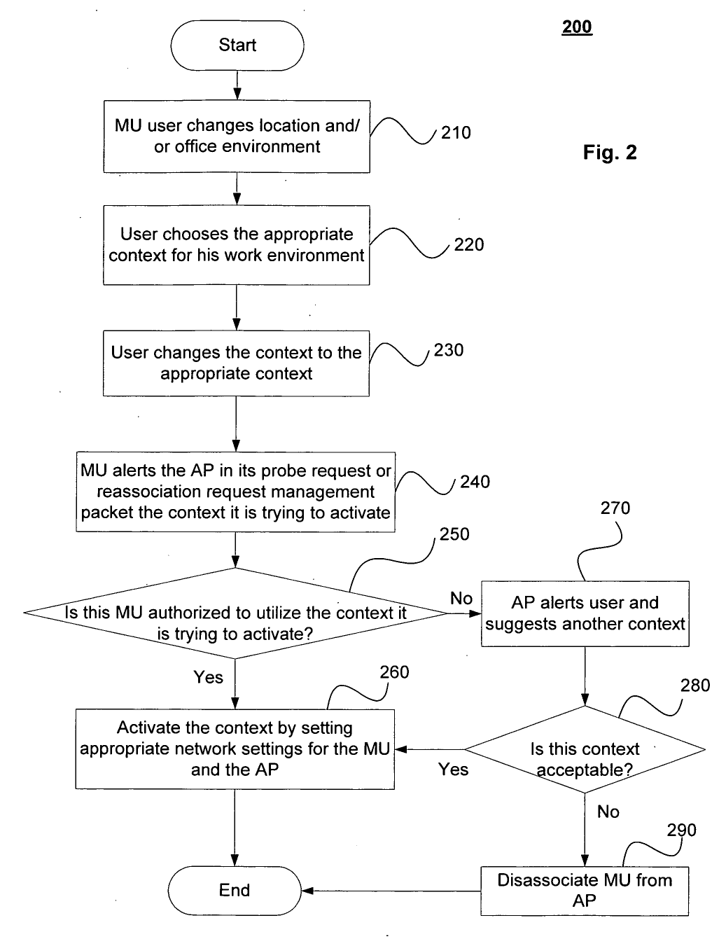

FIG. 2 shows a method 200 according to the exemplary embodiment of the present invention utilized to enable the use of main and sub contexts in a wireless network as the user changes their work environment. The method is described with reference to FIG. 1. Those skilled in the art will understand that other systems having varying configurations, and a multitude of Main-Contexts and Sub-Contexts may be used to execute the exemplary method.

In step 210, the user of an MU (e.g., MU 20) is either deciding to connect to the wireless network in a specific work environment, or has moved their work environment while being connected to either WLAN 100 or 200. For example, the user may be coming into work in the morning, or moving from their personal workspace (e.g., cubicle, office, etc) to a conference room for a meeting.

In step 220, the user of the MU 20 selects the proper Main-Context and Sub-Context for the new work environment. For example, the user of the MU 20 may select a Conference Main-Context and a Projection Sub-Context that include the functionalities as described above. Deciding which context to select may be based on the network and service level settings desired by the user. Those of skill in the art will understand that the described examples of main and sub-contexts are merely exemplary, and there can be any number of main-contexts and sub-contexts depending on the preferences of the organization and/or user.

In step 230, the user of the MU 20 applies and executes the appropriate Main-Context (and Sub-Context) on the MU 20. This action may be performed by a software application specifically designed for the implementation of contexts. The software application may have all the settings stored for each of the configured contexts, and allow the user to select the main-context (and sub-context) from lists, pull-down menus, a database, etc.

In step 240, after the user has selected the appropriate main-context and sub-context via a software application, the MU 20 then alerts the AP 60 of this request. The information regarding the contexts may be transmitted within the MU 20's probe request packet, re-association request packet, association request packet, a separate packet dedicated to the context setting of the MU, etc. Those of skill in the art will understand that the information regarding the contexts may be encrypted and stored in a plurality of formats and sent via any of a plurality of methods that allow the MU to communicate with the AP.

In step 250, the AP 60 receives the data packets containing the information regarding the contexts that the user of the MU 20 is selecting and the AP 60 assesses whether to allow the user to connect with the requested main-contexts and sub-context. The algorithms used to either allow or deny access to a certain context may be specified by the organization. For example, the organization may have different classes of users with different authorization levels for certain contexts and levels of service.

Also, the exemplary embodiments of the present invention may be used as a security measure. If no context is specified in any of the packets transmitted by an MU, the AP 60 may automatically designate the user as a Guest Context, and activate certain precautions such as limiting traffic, restricting access to some portions of the network, re-direct incoming traffic from the MU to a virus scan program, activate firewalls, etc.

In step 260, if it has been determined that the MU 20 is authorized to use the requested contexts, the settings and level of service that have been stored for the requested main-context and sub-context will be applied for the MU 20. There may exist default contexts that contain settings that have been preprogrammed. Moreover, the organization and/or user may be able to change the settings for default contexts, and add and create new contexts depending on the needs of the users and/or organization. These settings may include peer-to-peer networking settings, traffic based on VoIP, restricting of transmitted traffic, etc.

In step 260, once it has been verified by the AP 60 that MU 20 is authorized to use the requested contexts, the AP 60 would grant the MU 20 a wireless connection that incorporates the settings associated with the contexts. This may include network settings of the MU 20, and level of service settings of the AP 60.

In step 270, there may be a case where the Main-Context and Sub-Context requested by the user of the MU 20 are unacceptable according to the algorithms that have been predetermined by the organization. This may be because the user is not authorized to use the context, there may be a hard limit on the number of users utilizing the specific context, the particular AP is not configured for the requested context, etc. For example, because of Quality of Service (“QoS”) requirements, a particular AP may have a hard limit on the number of MUs that can associate with an AP and select a context that includes enablement of VoIP. Thus, even though a particular user may be authorized for a defined service level, the user may still be denied access to a context because other criteria not associated with the user may not be satisfied.

In this situation, the AP may suggest an alternative context to the user. The alternative context suggested by the AP 60 may be selected based on an algorithm defined by the organization, or there may be a default context that is suggested when any user is denied use of a requested context. In the example provided above of a hard VoIP limit, the AP may suggest the closest context to requested context that does not include VoIP enablement.

In step 280, the user may decide whether or not the context suggested by the AP 60 is acceptable. If the user finds the suggested context acceptable for the work environment, then the user will be connected to the wireless network with the suggested context applied (step 260). However, if the user finds the suggested context unacceptable for the situation and rejects the suggested alternative, as shown in step 290, the AP 60 may disassociate the MU 20 from the wireless network.

In addition, the AP may also monitor the MUs to determine their actual uses of resources in particular contexts. Based on this monitored usage, the AP may suggest or require a context switch on the part of an MU for the purpose of more efficiently using the network capabilities. To continue with the VoIP example started above, an MU may be operating using a context that has the VoIP enabled. However, the AP may determine that the MU has been operating for a defined period of time without using the VoIP capabilities. When a new MU requests a context that includes VoIP enablement, but the hard limit of VoIP users has been satisfied, the AP may send a request to original MU to determine if it can switch contexts in order to allow the new MU to be granted access to its desired context that includes VoIP enablement. This may be in the form of a request that may be accepted or declined by the original MU or in the form of a rule that requires the original MU to switch contexts. Other forms of context switching may also be based on priority levels for particular users, e.g., a higher priority user may be able to require that a lower priority user is context switched so that the higher priority user is granted access to its desired context.

In the above described examples, various functionality has been described for the MUs and the APs. Those of skill in the art will understand that this functionality may be implemented via hardware, software or a combination thereof on these devices. Where the functionality is implemented via software, this functionality may be included as part of separate software modules or as portions of one or more software applications implemented on the device.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A wirelessly enabled mobile unit (“MU”), comprising:
a memory storing a plurality of pre-defined contexts, each context including network settings for a defined operational mode;
a selection module to select a first context of the pre-defined contexts based on input from a user of the MU;
a transmitter to wirelessly transmit a request to operate in the first context, the request being directed to an access point (“AP”) that includes a coverage area within which the MU is located;
a receiver to receive a permission signal from the AP including permission to operate in the first context; and
a setting module to retrieve the network settings from the memory and apply the network settings corresponding to the first context to the MU.

2. The MU of claim 1, wherein the selection module receives a further input from the user indicating a second context of the pre-defined contexts and wherein the transmitter transmits a second request to operate in the second context to the AP, the receiver receives a second permission signal from the AP including permission to operate in the second context and the setting module retrieves the network settings from the memory and applies the network settings corresponding to the second context to the MU.

3. The MU of claim 1, wherein the receiver receives a denial signal from the AP indicating that the MU is denied operation in the first context.

4. The MU of claim 3, wherein the denial signal includes a second context of the pre-defined contexts selected by the AP.

5. The MU of claim 4, wherein the selection modules accepts the second context and the setting module retrieves the network settings from the memory and applies the network settings corresponding to the second context to the MU.

6. The MU of claim 1, wherein the transmitter transmits a further signal to the AP indicating that the network settings of the first context have been applied.

7. The MU of claim 1, wherein the MU is one of a personal digital assistant, a laptop computer and a mobile computing device.

8. The MU of claim 2, wherein the AP is a plurality of APs and wherein the first and second requests are transmitted to different APs.

9. The MU of claim 1, wherein the defined operational modes include a personal office mode and a conference mode.

10. The MU of claim 2, wherein the second context is a sub-context of the first context and the applied network settings of the first context remain applied when the network settings of the second context are applied.

11. The MU of claim 2, wherein the first and second contexts are main contexts and the applied network settings of the first context are cancelled when the network settings of the second context are applied.

12. The MU of claim 1, wherein the request is transmitted via one of a probe request packet, a re-association packet, an association packet and a packet dedicated to a context setting.

13. A method, comprising:
selecting a first context from a plurality of pre-defined contexts, each context including network settings for a defined operational mode;
requesting authorization to operate in the first context;
receiving permission to operate in the first context; and
applying the network settings for the first context.

14. The method of claim 13, further comprising:
receiving a suggestion for a second context from the plurality of pre-defined contexts when permission to operate in the first context is denied.

15. The method of claim 14, further comprising:
sending an indication that the second context is acceptable; and
applying the network settings for the second context.

16. The method of claim 13, further comprising:
selecting a second context of the pre-defined contexts;
transmitting a second request to operate in the second context;
receiving a second permission signal including permission to operate in the second context; and
applying the network settings corresponding to the second context.

17. The method of claim 13, further comprising:
transmitting a further signal indicating that the network settings of the first context have been applied.

18. The method of claim 16, wherein the second context is a sub-context of the first context and the applied network settings of the first context remain applied when the network settings of the second context are applied.

19. The method of claim 16, wherein the first and second contexts are main contexts and the applied network settings of the first context are cancelled when the network settings of the second context are applied.

20. An access point (“AP”), comprising:
a memory storing a plurality of pre-defined contexts, each context including network settings for a defined operational mode;
a receiver to receive a request from a mobile unit (“MU”) to enable a first context of the pre-defined contexts;
a permission module to determine if the MU has permission to enable the first context and configure one of a permission signal and a denial signal for the MU; and
a transmitter to wirelessly transmit the one of the permission signal and denial signal to the MU.

21. The AP of claim 20, further comprising:
a settings module to apply the network settings corresponding to the first context to the AP when the MU has permission to enable the first context.

22. The AP of claim 20, wherein the permission module further selects a second context of the plurality of pre-defined contexts for the MU when the permission for the first context is denied and wherein the denial signal includes the second context.

23. A system, comprising:
a mobile unit including a plurality of predefined contexts, each context including corresponding network settings, the mobile unit selecting one of the predefined contexts and formatting and transmitting a request signal to enable the one of the predefined contexts; and
an access point including the plurality of predefined contexts, the access point receiving the request signal from the mobile unit and determining if the mobile unit has permission to enable the one of the predefined contexts, the access point sending one of a permission signal and a denial signal to the mobile unit, wherein, when a permission signal is sent, the access point and the mobile unit apply the network settings corresponding to the one of the predefined contexts.
